(19) United States
(12) Patent Application Publication
(10) Pub. No.: US 2013/0304450 A1
(43) Pub. Date: Nov. 14, 2013

(54) Method for Unified High-Level Hardware Description Language Simulation Based on Parallel Computing Platforms

(71) Applicant: STARDFX TECHNOLOGIES, INC., Sunnyvale, CA (US)

(72) Inventors: Tso-Sheng Tsai, Saratoga, CA (US); Laung-Terng Wang, Sunnyvale, CA (US)

(73) Assignee: StarDFX Technologies, Inc., Sunnyvale, CA (US)

(21) Appl. No.: 13/887,636

(22) Filed: May 6, 2013

Related U.S. Application Data
(60) Provisional application No. 61/644,107, filed on May 8, 2012.

(51) Int. Cl. G06F 17/50

(52) U.S. Cl. CPC G06F 17/5022
USPC 703/14

(57) ABSTRACT

A method to build a unified simulator for simulating a design on a parallel computing platform. The parallel computing platform comprises two or more (processors) cores which are deemed as an integral part of the unified simulator. The design is modeled in a high-level hardware description language. The design is first translated into a set of elements each comprising one or more simulation operations. Simulation operations from elements are next assigned, dynamically or statically, to one or more cores in a central processing unit (CPU) or in a multi-core system on the parallel computing platform to perform a parallel logic or fault simulation. Multiple (simulation) operation processing systems are used to process simulation operations in parallel. Simulation data in each element is managed to be self-contained so a fine-grained parallelism among multiple cores is achieved. Multiple communication links are available to enable the unified simulator to work with other third-party software to create new applications.

### FIELD OF THE INVENTION

The present invention generally relates to the field of logic design and test of integrated circuits. Specifically, the present invention relates to the field of logic and fault simulation for digital integrated circuits.

### BACKGROUND

Simulation is a powerful set of techniques that are heavily used in digital circuit verification, test development, design concept validation, performance evaluation, debugging and diagnosis. During the design stage, logic simulation is performed to help verify whether the design meets its specifications, or contains any design errors. It also helps locate design errors which escape to fabrication during design debugging. In test development, faulty circuit behavior is simulated with a set of test patterns, in order to assess the pattern quality, and to guide further pattern development. Simulation of faulty circuits is referred to as fault simulation, and is also used during fault diagnosis, where test results are used to locate manufacturing defects within the actual hardware.

Modern digital circuit designs are mostly described in high-level hardware description languages. Verilog HDL and VHDL are two major hardware description languages widely adopted. A high-level hardware description language allows design engineers to describe a digital circuit as a mix of power lines, transistors, MOS switches, logic gates, register-transfer level (RTL) elements, and behavioral- and higher-level functions. Other than the logic circuit, the description language can also include control and driving mechanisms (commonly known as “testbenches”) to perform simulations on the digital circuit itself. A complete simulation system should be able to handle all of the transistors, switches, logic gates, and RTL, behavioral-level, and higher-level statements.

Prior art logic simulation include compiled-code (Wang 1987) and primitive-based (Fujimoto 1990; Bailey 1994; Avril 1999) simulation techniques—either event-driven based or cycle based—which is limited to a single central processing unit (CPU) or to a group/network of powerful processors. The idea of compiled-code simulation is to translate the design into a series of machine instructions, or programming codes such as C/C++ languages that model the functionality of individual logic constructs such as gates, RTL elements, or high-level behavioral/system statements. The main focus is to achieve the highest performance possible on a typical CPU or a multi-core/multi-CPU system.

For cycle-based techniques, further circuit logic optimization is performed to improve the simulation performance by sacrificing certain simulation accuracy. In general, logic optimization and levelization have to be performed prior to the code generation process to reduce the computation need of simulation. In contrast to cycle-based simulation, event-driven simulation exhibits much higher simulation resolution and accuracy with the penalty of lower speed; however, due to its flexibility and ability to handle complex behavioral-level and higher-level functions, event-driven simulation has been the dominating paradigm for meeting the mainstream logic simulation (and fault simulation) need of digital integrated circuits.

It is noted that both event-driven and cycle-based simulation techniques are not mutually exclusive. Many efforts have tried to merge the merits of both techniques to create a better simulation solution. One typical example is to convert multiple logic gates into one big logic unit to speed up the computation of logic gate states.

Another example is to partition a design into smaller blocks where each block has internal states independent of other blocks. The internal signal timing and related properties in the block are also independent of those in other blocks. Under this condition, it will be possible to perform cycle-based simulation inside each block. It will also be possible to assign each block to a compute unit (a core or a processor) in a multi-core/multi-CPU system.

Regarding fault simulations, the major difference between logic simulation and fault simulation lies in the nature of the non-idealities they deal with. Logic simulation is intended for identifying design errors using the given specifications or a known good design as the reference. Design errors may be introduced by human designers or electronic design automation (EDA) tools, and should be caught prior to physical implementation. Fault simulation, on the other hand, is concerned with the behavior of fabricated circuits as a consequence of inevitable fabrication process imperfections. The manufacturing defects (e.g., wire shorts and opens), if present, may cause the circuits to behave differently from the expected behavior. Fault simulation generally assumes that the design is functionally correct.

Although fault simulation is rooted in logic simulation, many techniques have been developed to quickly simulate all possible faulty behaviors. The prior art techniques include serial, parallel, deductive, differential, and concurrent fault simulation. All these techniques have their respective advantages and disadvantages. However, from performance (simulation efficiency) and memory management points of view, concurrent fault simulation based on event-driven (logic) simulation has become the dominant solution widely used in the semiconductor industry.

In fact, fault simulation is a form of multi-state logic simulation which can process multiple designs at the same time, when each design has a portion different from other designs.

The relationship between fault simulation and logic simulation can be illustrated with certain popular commercial simulators. For example, Verilog-XL and NC-Verilog (both from Cadence Design Systems), VCS (from Synopsys), and ModelSim (from Mentor Graphics), are typical event-driven simulators. Commercial fault simulators, such as TurboFault (from SynTest Technologies), Z01X (from Winterlogic), and Verifault (from Cadence Design Systems), are based on concurrent fault simulation. Verifault, in particular, shares most of the simulation techniques with Verilog-XL.

Due to the rapid increase of design complexity and circuit size in modern integrated circuits and systems, current commercial logic/fault simulators start having a problem to deliver reasonable performance on simulating or fault-grading designs containing multimillion gates on a CPU system. The CPU system may contain one or more CPUs; each CPU may further contain one or more cores. For clarity, a CPU system that contains two or more cores in the CPU is referred to as a multi-core CPU system. A CPU system that contains two or more CPUs is referred to as a multi-CPU system.

In the meantime, those legacy software simulators, developed decades earlier, are not flexible and efficient enough to take advantage of recent multi-core/multi-CPU technologies advanced by processor vendors, such as Intel, AMD, and NVIDIA. Particularly, the graphical processing unit (GPU) architecture, promoted by companies such as NVIDIA and AMD/ATI, which can contain more than 500 processors or cores may provide tremendous computational power for simulations. The GPU architecture can be the solution to address the need for pursuing a faster logic/fault simulator. For clarity, a GPU system may contain one or more GPU cards (a.k.a. GPU units); each GPU card or GPU unit may contain two or more GPU cores. It is widely available now that one GPU card may contain as many as 1000 cores where each core can perform computational jobs independently.

One main difficulty of implementing logic/fault simulation on a CPU or GPU system is the heavy traffic among CPU cores, GPU cores, and main memory. Data congestion and traffic jam could severely slow down the overall simulation performance. Another challenge is the limited data allocation capability of each core in a GPU unit. Data communication among the main CPU cores and the GPU cores can also generate heavy data traffic which can further slow down the overall simulation performance.

Prior art on implementing GPU-architecture-based logic simulators have been focused on simplifying the computation need for each GPU processor, and reducing the data traffic between the GPUs and the CPU system. See US Pat. Applications 20100274549 by Tal, et al.; 20110067016 by Mizrachi, et al.; and 20110191092 by Mizrachi, et al. Various design partition methods had been proposed to address those GPU-based simulation problems.

These partition methods tend to examine the signals and data dependencies among different parts (or blocks) in a logic circuit. If two parts of the circuit are logic-wise and data-wise independent of each other, then each part may be safely simulated by two GPU cores at the same time. Unfortunately, most logic circuits cannot be partitioned easily. Oftentimes, parts of the circuit are mutually dependent, i.e., Partition A needs outputs from Partition B when Partition B also needs outputs from Partition A. This means Partitions A and B cannot be simulated at the same time with two different GPU cores. This implies most logic circuits have very limited parallelism in nature. This indicates most GPU cores may stay idle during simulation causing poor overall simulation performance.

Another problem of these partitioning methods is that most behavioral-level and higher-level elements in a design cannot be partitioned, nor are they easy for a GPU to process. This means those partition-based simulators can only cover logic gates and RTL elements in a design. They may need another simulator to process other difficult elements, such as behavioral testbenches. Eventually, the GPU-based simulator can only serve as a co-simulator or a simulation accelerator to the main logic simulator running on the main CPU system. A third-party logic simulator, such as NC-Verilog or VCS, would have to be run to drive the GPU-based co-simulator. This will greatly limit the usage of the GPU-based co-simulator.

Hence, there is a need for a unified high-level simulation method that can perform logic or fault simulation on a GPU-based parallel computing platform, without using the partitioning approach and without interface to a third-party simulator which serves as the main simulator.

### SUMMARY OF THE INVENTION

A typical design may contain a circuit model which comprises a plurality of logic gates, switches, RTL elements, high-level statements and tasks. The circuit model may be described in a netlist format, a register-transfer-level (RTL) format, or a behavioral-level/higher-level model. Assume the design is to be verified or tested by one or more functional patterns that may be modeled at a behavioral or higher level, termed as testbenches. Both circuit model and testbenches may be modeled in a hardware description language, such as Verilog HDL (IEEE 1364-2001) or VHDL (IEEE Std. 1076-2002).

In a first embodiment of the present invention, the circuit model and behavioral testbenches are translated altogether into a set of element containers. Not only is the circuit model translated, the testbenches and behavioral-/higher-level statements are also translated. Each element container may be a primitive, a macro that includes two or more primitives, or a module that includes two or more macros. The translation process ensures that each element container is data self-sufficient, i.e., other than the boundary event signals, each element container has enough data to perform circuit state evaluation and event scheduling calculation independently. In dong so, each element can be processed by one simple GPU core independently without worrying about corrupting the simulation of any other element containers (short as ‘elements’ in the following references). The elements can be processed within the main CPU, individual core of a CPU or a multi-CPU system (collectively, referred to as a CPU/multi-CPU system) as well. Any design changes can be re-synthesized incrementally to save time. All design signal names, structures, hierarchy information, etc., are stored in the design database.

In a second embodiment of the present invention, elements are assigned to a GPU unit as long as the GPU unit has available memory space. No special partition method is needed. The only consideration is to put as many elements, be they logic gates, RTL elements, behavioral-/higher-level statements, or testbench drivers, to the GPU unit. Only left-over elements will be diverted to the main CPU/multi-CPU system. Special elements, such as memory arrays, file I/Os, message display functions, etc., will be assigned to the main CPU/multi-CPU system because only the main CPU/multi-CPU system has access to file system and operating system.

When multiple GPU units (referred to as a multi-core system) are available, the elements may be evenly distributed to each GPU unit. Again, there is no special partition method applied. The goal is still to put as many elements to the GPU memories as possible.

The key invention here is that the main CPU/multi-CPU system and the GPU/multi-core system are deemed as an integral part of the simulator. There is no concept of co-simulation. The simulator-controlled system, when residing in both the main CPU/multi-CPU system and the GPU/multi-core system, governs the progress of simulation on the CPU and GPUs directly. Hence, such a CPU/GPU integrated simulator can be termed as a “unified simulator.” The simulator is fully self-contained. It can handle testbenches directly; hence it can perform simulations on its own without interface to any other third-party software simulators.

In a third embodiment of the present invention, the GPU cores can simulate transistors, MOS switches, logic gates, RTL statements, and behavioral-/higher-level statements. That is, the GPU cores are not merely limited to process logic gates and RTL primitives.

An event processing system under the control of a CPU/multi-CPU system manages event scheduling, event canceling, and multiple event generations. Given 500 GPU cores, a linear speedup factor of 500× may be realized on processing matured events. This is the maximum parallelism which can be reached on a parallel computing platform. Since each element is self-contained, this means each event also has self-contained data sufficient enough for event processing. This implies each GPU processor can handle an event independently without causing conflicts with other processors to result in data incorrectness.

The same techniques can be applied to a multi-state simulator, or a fault simulator.

To ensure 100% full compatibility with currently available commercial high-level hardware description language logic simulators, a minimum of 256 different logic strength values may be supported, instead of mere 4 logic state values −0, 1, X, and Z, used in a prior art system.

The parallelism of the simulation is built upon the processing of individual matured events and element evaluations. The processing of individual matured events and element evaluation are considered as the most basic operations in a simulator. Those basic simulation operations are defined as ‘atomic operations.’ Atomic operations are dynamically assigned to every CPU or GPU core in the multi-core systems, one atomic operation per core at a time. This is a fine-grained based parallelism, and in theory, it has the best parallel computing performance that can be reached on hardware design simulations where there are millions of events and elements active at the same time.

Above the atomic operation processing level, various optimization methods are available to further improve the simulation performance at a higher level. The optimization methods can be divided into two different categories: design based partition methods and data based optimization methods.

The design based partition methods include the typical Structure/Topology Based Partition method, Overlapped Partition method, Functional Partition method, Static Partition method, Single Core Assignment method, and Sparse Partition method. Depending on the nature of the optimization, one or more said elements may be assigned to an element group, dynamically or statically, said one or more cores may be assigned to said core group, dynamically or statically.

The data based optimization methods include Element Compaction method, Design Element Vectorization method, Code Splicing method, and a method to handle a 3-dimentional (3D) memory array.

Further data/code optimization techniques include: dead code removal; function redundancy removal; un-reachable code removal; pre-calculation of design elements which have constant output values; data pre-fetching; code segments re-ordering; direct C/C++ language or assembly code generation; and data compaction for parallel operations, etc.

Future GPU/multi-core system may contain 3-dimensional (3D) memory arrays to increase memory system performance. Special arrangement is needed to store element data to the 3D memory to improve the simulation performance.

The design translator may directly generate C/C++ language codes or assembly codes for each design element. This will increase the computation efficiency for the design elements.

The unified simulation method can be applied to other hardware or system design simulators as well. Analog circuit simulators, typically the SPICE simulator, can also be benefited from the same unified simulation method. Part of an analog circuit simulator would be based on matrix data processing and computation method which is vector processing like in nature. Vector processing can be easily mapped to GPU cores for drastic performance improvements. The rest of the analog circuit simulators would be mainly event-based operations which can be handled by the method of the present invention.

Therefore, a mixed-signal analog and digital circuit simulator can be implemented under the same unified high-level language simulation method. With the enhancement of the design translator, the simulator will be able to handle a design which has various parts implemented in different high-level hardware description languages. For instance, one part of the design may be implemented with the Verilog HDL language when the rest of the design is coded with the VHDL language. This will create a high-level mixed-language simulator.

For system simulations, where part of the design may be implemented in a high-level hardware description language, certain parts are analog circuits, and the rest of the design is coded with programming language such as the C/C++ language, the same unified simulation method will also work for such a system simulation.

Lately, different parallel processing architectures have been proposed as computing platforms to the GPU/multi-core solution. One typical example is Intel's Xenon Phi co-processor based on Intel's Many Integrated Core (MIC) architecture. The Xenon Phi co-processor contains 50-60 high performance processor cores. Each core has higher performance and computation capacity than the GPU core peers.

The high speed cache data coherence system of the MIC architecture can reduce the performance penalty of data contention issues among processor cores. This will allow multiple cores to modify the same data simultaneously. This will also allow a more flexible processing on atomic operations.

The present invention can be easily applied to the Intel MIC architecture. A main difference between current GPU/multi-core system and the Intel MIC architecture is that the Intel MIC architecture has a smaller number of cores each having a higher computation capacity than its counterpart. Since the Intel MIC core has a better performance, it may be beneficial to reserve one or more cores only for certain types of atomic operations. The rest cores will handle generic atomic operations.

Since dynamic memory allocation functions are accessible to every Intel MIC core, fault simulation can be implemented on the MIC architecture to take advantage of the power of parallel processing. To increase simulation performance and to take advantage of the bigger cache memory size on the Xenon Phi co-processor, design elements should be made as large as possible.

The aforementioned statements also hold true for any multi-core systems similar to the Intel MIC architecture.

### THE BRIEF DESCRIPTION OF DRAWINGS

FIG. 1 shows a diagram of a prior art system based on a main-simulator/co-simulator method with element/task partition parallelism;

FIG. 2 shows a diagram of a single simulator, based on a unified high-level hardware description language simulation method, in accordance with the present invention;

FIG. 3 shows a structure diagram of the unified high-level hardware description language simulator, in accordance with the present invention;

FIG. 4 is a functional diagram of the simulation engine of the unified high-level hardware description language simulator, in accordance with the present invention;

FIG. 5 shows a mixed event processing and element evaluation flow of atomic operations in a main simulation loop executed by the simulation engine, in accordance with the present invention;

FIG. 6 shows an event processing system in the simulation engine using the mixed event processing and element evaluation flow of FIG. 5, in accordance with the present invention;

FIG. 7 shows an element evaluation system in the simulation engine using the mixed event processing and element evaluation flow of FIG. 5, in accordance with the present invention;

FIG. 8 shows a Structure/Topology Based Partition method for simulation performance optimization, which is a first embodiment of a design partition based optimization method, in accordance with the present invention;

FIG. 9 shows an Overlapped Partition method for simulation performance optimization which is a second embodiment of a design partition based optimization method, in accordance with the present invention;

FIG. 10 shows a Functional Partition method for simulation performance optimization, which is a third embodiment of a design partition based optimization method, in accordance with the present invention;

FIG. 11 shows a Functional Partition method for supporting multiple multi-core systems for simulation performance optimization, which is a fourth embodiment of a design partition based optimization method, in accordance with the present invention;

FIG. 12 is a Static Partition method for simulation performance optimization, for simulation performance optimization, which is a fifth embodiment of a design partition based optimization method, in accordance with the present invention;

FIG. 13 shows a single core assignment method for simulation performance optimization, which is a sixth embodiment of a design partition based optimization method, in accordance with the present invention;

FIG. 14 is a Sparse Partition method for simulation performance optimization, for simulation performance optimization, which is a seventh embodiment of a design partition based optimization method, in accordance with the present invention;

FIG. 15 shows an Element Compaction method, which is a first design data based optimization method, in accordance with the present invention;

FIG. 16 is a design element vectorization method, which is a second design data based optimization method, in accordance with the present invention;

FIG. 17 shows a splicing method, which is a third design data based optimization method, in accordance with the present invention; and

FIG. 18 shows a method to handle a 3D memory array, which is a fourth design data based optimization method, in accordance with the present invention.

### DETAILED DESCRIPTION OF THE INVENTION

The following description is presently contemplated as the best mode of carrying out the present invention. This description is not to be taken in a limiting sense but is made merely for the purpose of describing the principles of the invention. The scope of the invention should be determined by referring to the appended claims.

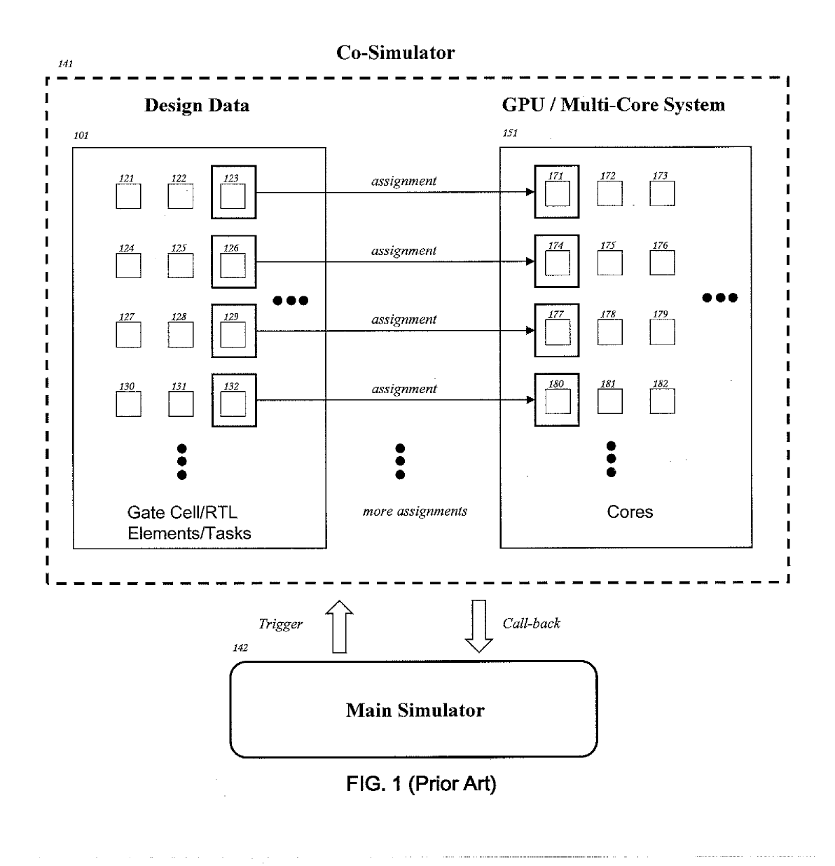

FIG. 1 shows a diagram of a prior art system based on a main simulator/co-simulator method with element/task partition parallelism. The Design Data 101 represents a hardware design which contains gate-level and RTL design descriptions. The design is partitioned into individual elements/tasks 121-132 and more. An element can be a transistor, a logic gate, a cell, a gate-level module, or an RTL module. An element can be a combination of multiple modules as well. An element can also be referred to as a simulation task. A simulation task means a collection of simulation operations for one partition of the design. For the purpose of simplicity, task will be represented by the term ‘element’ from now on. Certain data or control independency criteria among elements or tasks will have to be preserved to create a successful design partitioning. The GPU/Multi-Core System 151 contains processor cores 171-182 and more. Each element/task will be assigned to one core. In this case, Element 123 is assigned to Core 171, Element 126 to Core 174, Element 129 to Core 177, and Element 132 to Core 180. Each core will handle all of the simulation operations of the element when the element to core assignment stays active. These include event handling, logic value evaluation, event scheduling, and simulation operations. The assignment is mostly static, i.e., a core may have to handle multiple simulation operations for the element/task before the core is released to handle other elements/tasks. It is highly possible that the core may stay idle or be blocked for a certain period of time, waiting for data from other elements to become available.

In FIG. 1, the GPU/Multi-Core system simulator 151 is acting as a Co-Simulator 141. The co-simulator 141 needs to be attached to a Main Simulator 142 to perform a complete high-level hardware language simulation. A Main Simulator 142 may be a commercial logic simulator, such as NC-Verilog, VCS, or ModelSim. Main Simulator 142 will send out signals to trigger 141 to perform simulations then wait for the call-back signal from 141 to continue the next stage of simulation. The main simulator is required mainly to handle behavioral-level or higher-level statements when the co-simulator can process gate-level and RTL statements only.

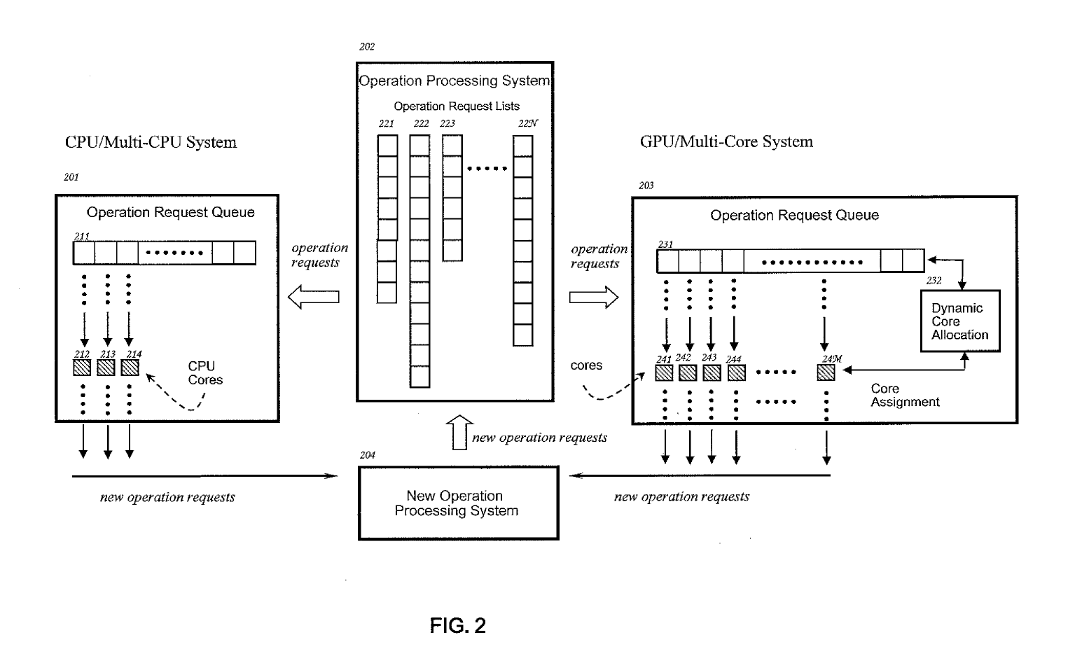

FIG. 2 shows a single simulator to perform parallel simulation for a high-level hardware description language based design, in accordance with the present invention. The parallelism is explored based on atomic operations. The concept of design partitioning is abandoned at the atomic operation level. A simulation is deemed as a collection of atomic operations. An atomic operation can be an event processing operation, an element evaluation operation, an event scheduling operation, or a system I/O operation, etc. Atomic operations are the smallest operations processed in a simulator. A task or an element may be a collection of multiple atomic operations. Atomic operation requests can come from any gate-level, RTL, behavioral-level, or higher-level statements and elements.

All new (atomic) operation requests will be sent to the Operation Processing System 202 first. The new operation requests are stored in the Operation Request Lists 221-22N. The Operation Request Lists 221-22N may be implemented in data structures such as lists, queues, stacks, arrays, temporary variables, dynamically allocated memories, or a mixture of above data structures. An operation request will be fetched from the Operation Request Lists 221-22N, and depending on the nature of the request, the operation request will be sent to either the CPU/Multi-CPU System 201 or the GPU/Multi-Core System 203. In both systems 201 and 203, incoming operation requests will be stored in the Operation Request Queues 211 and 251, respectively. The Operation Request Queues 211 and 251 may be implemented in data structures such as lists, queues, stacks, arrays, temporary variables, dynamically allocated memories, or a mixture of above data structures. In the CPU/Multi-CPU System 201, requests will be fetched from the Operation Request Queue 211, and then will be processed by the CPU Cores 212, 213, and 214. Any new operation requests generated by the CPU cores will be fed to the New Operation Processing System 204. After further processing in the New Operation Processing System 204, one new batch of operation requests may be generated, and will be sent back to the Operation Processing System 202. The New Operation Processing System 204 also has a bypass path; new operation requests generated from the CPU Cores 212-214 may bypass the New Operation Processing System 204, and enter the Operation Processing System 202 directly.

On the right side of FIG. 2, operation requests for the GPU Card/Multi-Core System 203 to process will be stored at the Operation Request Queue 231 first. Next, the Dynamic Core Allocation System 232 will search for any free cores, pick up a new operation request from the Operation Request Queue 231, and assign it to a next available core. The function of the Dynamic Core Allocation System 232 is to ensure each of the Cores 241-24M be fully occupied with processing operation requests at any given time. No single core may stay idle, and be blocked awaiting data to become available from other cores. Any new operation requests generated from the Cores 241-24M will be sent to the New Operation Processing System 204, and eventually, another new batch of atomic operation requests will enter the Operation Processing System 202. Another iteration of atomic operation processing cycle will start again, and a simulation is mainly a collection of multiple iterations of atomic operation processing cycles. The New Operation Processing System 204 also has a bypass path; new operation requests generated from the Cores 241-24M may bypass the New Operation Processing System 204, and enter the Operation Processing System 202 directly.

Both the CPU/Multi-CPU System 201 and GPU/Multi-Core System 203 in FIG. 2 are deemed as integral parts of the simulator. There is no distinction between a main-simulator and co-simulators; hence it is a unified simulation method. The CPU/Multi-CPU System and GPU/Multi-Core System cores may be dynamically assigned with atomic operations, based on the nature of the atomic operations, to maintain a peak simulation performance. Every CPU/Multi-CPU and GPU/Multi-Core System core may be assigned with atomic operations one operation at a time. A core will be released to process other atomic operations as soon as it completes processing the current atomic operation. Since an atomic operation request will only be created when all of its prerequisite data become available, When a CPU core or a GPU/Multi-Core System core is assigned with a new atomic operation, the core will not have to wait for certain atomic operations in other cores to finish first before the core can resume processing the new atomic operation. This means CPU/Multi-CPU and GPU/Multi-Core System cores may not be blocked by other atomic operations, and may not enter an idle state or a wait state. This means the cores will never be blocked by other operations, and thus will never enter an idle or wait state.

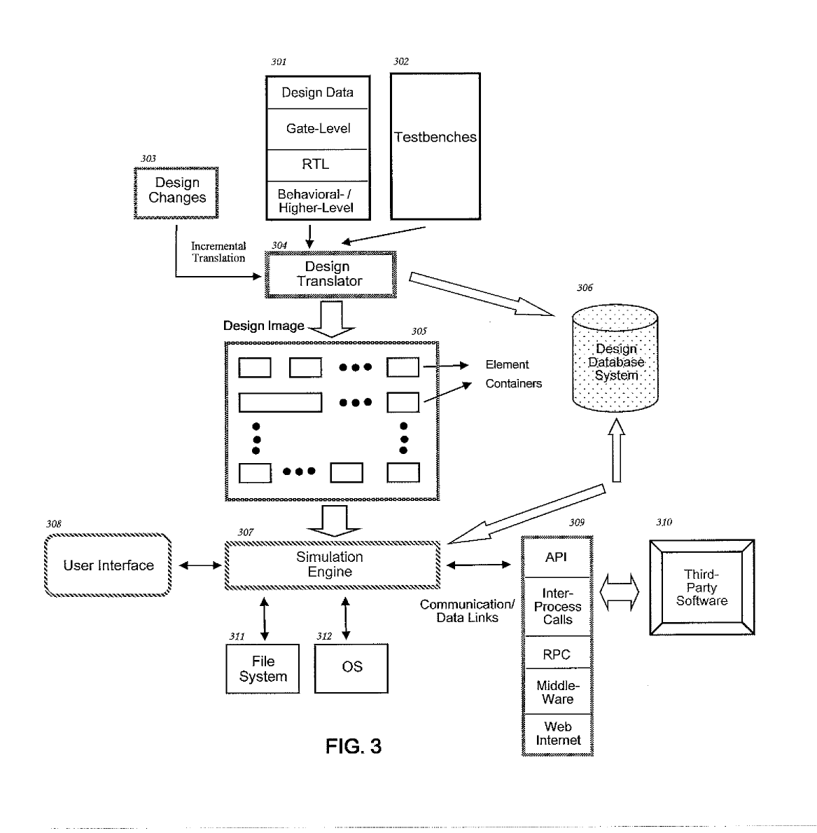

FIG. 3 shows a structure diagram of the unified high-level hardware description language simulation method, in accordance with the present invention. Design Data 301 may contain any gate-level, RTL, behavioral-level, or higher-level statements. Along with Test-benches 302 and Design Changes 303, they will be translated by a Design Translator 304 into a Design Image 305. A design database will be created at the same time for the Design Database System 306 which will keep related design data information for future design data referencing requests. The Design Image 305 will be fed to the Simulation Engine 307 to perform actual simulation operations. The Simulation Engine 307 has a communication link to the User Interface 308 for a user to control the simulation. It also has communication links to the File System 311 and, the Operating System (OS) 312 to perform various system tasks such as data file reading/writing, and message displaying, etc. The communication link between 307 and 309 will allow the Simulation Engine 307 to work together with other third-party software 310 through various communication methods, including Application Programming Interface (API), Inter-Process Calls, Remote Procedure Call (RPC), Middle-ware, and Web/Internet access.

The Design Image 305 of FIG. 3 contains the simulation data representatives of the original high-level language design statements. Transistors, logic gates, RTL statements, and behavioral/higher level statements will be translated into design elements to be used by the simulator. Design elements, or Element in short, may be transistors, logic gates, single RTL statements, or single behavioral/higher lever statements. An element may also be multiple logic gates, a design module, a collection of multiple modules, etc. An element may also be a collection of atomic operations happening in a transistor, in a cell, in a module, or in a set of modules. The data in each element should be self-sufficient to cover the need of every atomic operation in the element, where ‘self-sufficient’ means that other than the boundary data and signals on the element, every atomic operation in the element can be processing without accessing data from other elements.

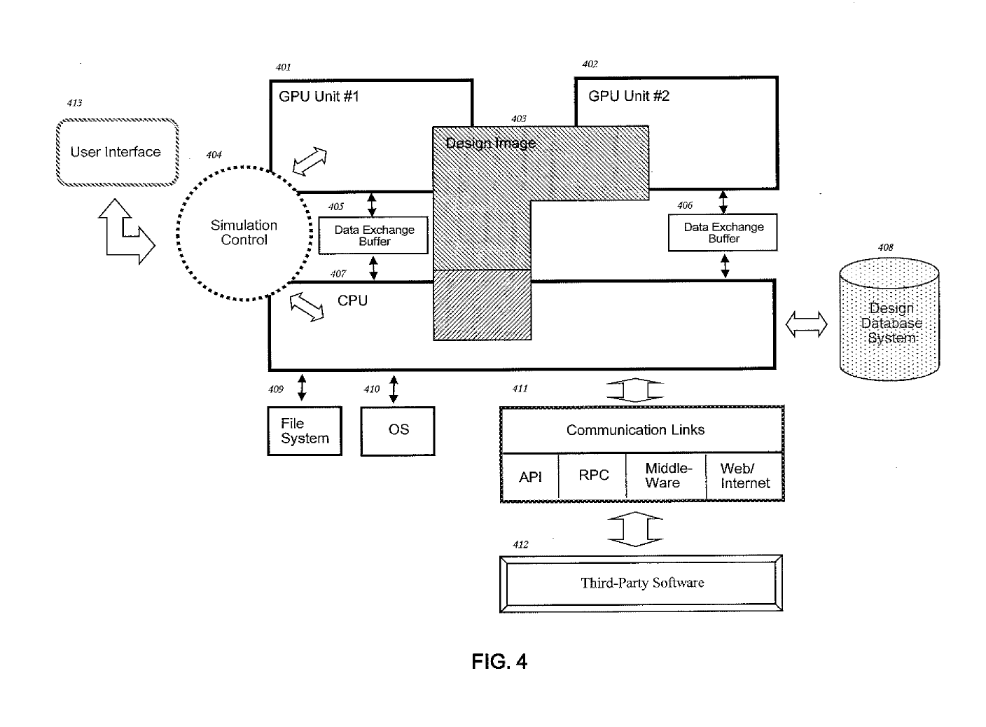

FIG. 4 shows a functional diagram of the simulation engine, in accordance with the present invention. The functional diagram further elaborates the details of the Simulation Engine 307 of FIG. 3. The Simulation Engine 307 covers the GPU Unit #1 401, the GPU Unit #2 402, and the CPU System 407, in this system configuration. The Design Image 403 is stored among 401, 402, and 407. Two Data Exchange Buffers 405 and 406 exist between 401/407 and 402/407, respectively. The Simulation Control 404 has an overall control over 401, 402, and 407; hence 401, 402, and 407 are deemed as integral and equal parts inside the simulation engine. User Interface 413 can control the simulation engine through the link to the Simulation Control 404. The CPU 407 maintains links to the File System 409 and the Operating System (OS) 410 to perform certain system operations. The link from the CPU 407 to Communication Links 411 will allow the Simulation Engine 307 to work with other Third-Party Software 412 via various communication methods. The CPU 407 also maintains a connection to the Design Database System 408 for any design data referencing needs.

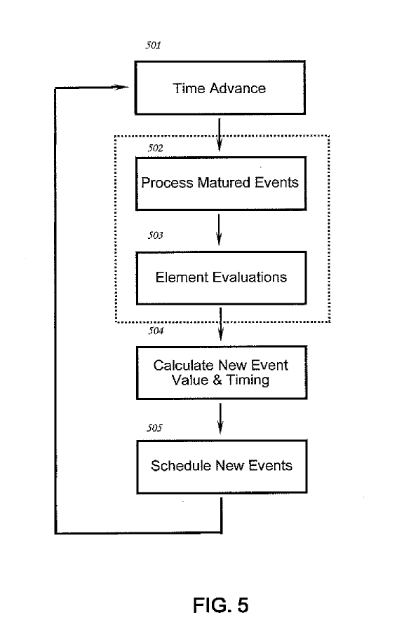

FIG. 5 shows a mixed event processing and element evaluation flow of atomic operations in a main simulation loop executed by the simulation engine, in accordance with the present invention. To process atomic operation requests in a simulation, first, the simulation time will be advanced at the Time Advance stage 501. A new simulation time will create matured event processing requests during the Process Matured Events stage 502. Operations to process matured events are considered as atomic operations. After matured events are processed at 502, new element evaluation operation requests will be produced during the Element Evaluations stage 503. After element evaluation operations are processed at 503, the Calculate New Event Value & Timing stage 504 will generate new event operation requests, and forward the new requests to the Schedule New Events stage 505 to process event scheduling operations. Element evaluation operations and event scheduling operations are considered as atomic operations. The Process Matured Events stage 502 and the Element Evaluation stage 503 will consume the majority of the CPU and GPU/Multi-Core system computation time. All of the simulation operations are dissected into a collection of atomic operations. In a simulation, CPU and GPU/Multi-Core System cores will spend most of their computation time on processing atomic operations. There is no concept of design partitioning at this atomic operation processing level.

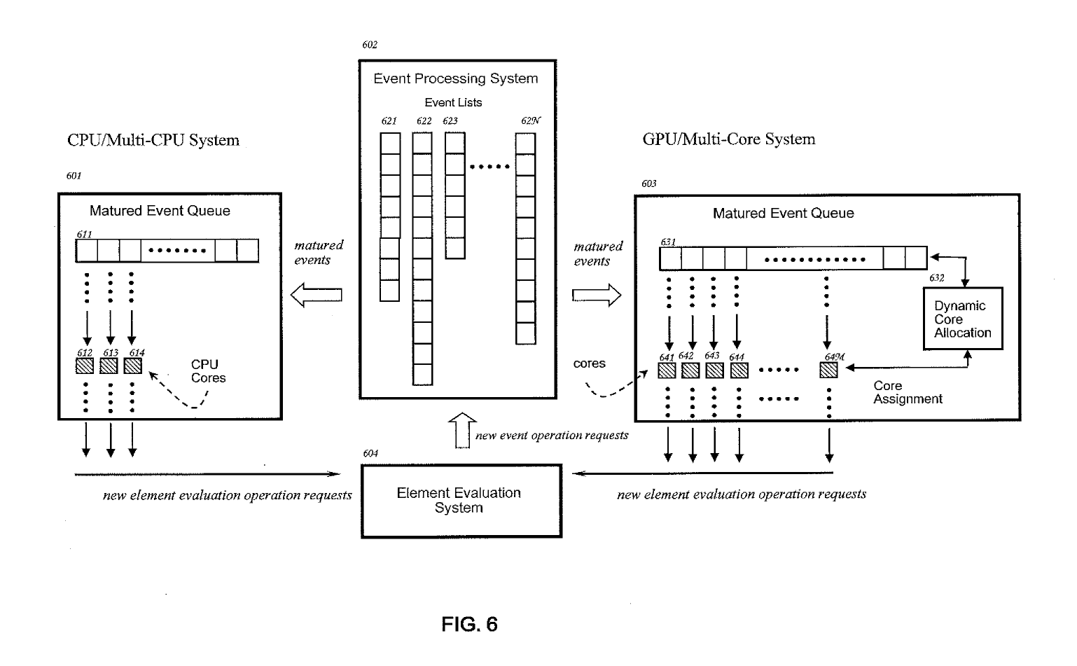

FIG. 6 shows an event processing system in the simulation engine using the mixed event processing and element evaluation flow of FIG. 5, in accordance with the present invention. First, new event operation requests are sent to the Event Processing System 602. Operation requests are stored in Event Lists 621-62N. A request will next be fetched from the Event Lists 621-62N, and depending on the nature of the request, will be sent to either the CPU/Multi-CPU System 601 or the GPU/Multi-Core System 603. New event operation requests will be stored in the Matured Event Queues 611 and 651, respectively. Next, in the CPU/Multi-CPU System 601, event operation requests will be picked up from the Matured Event Queue 611, and processed by the CPU cores 612-614. Any new element evaluation operation requests, generated by the cores, will be fed to the Element Evaluation System 604 which will then perform element evaluation operations. If there are any new event operations generated from the element evaluation operations, the Element Evaluation System 604 will send a new batch of event operation requests back to the Event Processing System 602.

On the right side of FIG. 6, new event operation requests for the GPU/Multi-Core System 603 will be stored at the Matured Event Queue 631. Next, the Dynamic Core Allocation System 632 will search for any free cores, pick up an event operation request from the Matured Event Queue 631, and assign the operation to a next available core. The function of the Dynamic Core Allocation System 632 is to keep each of the cores 641-64M busy all the time. No cores may stay idle. Any new element evaluation operation requests generated from the cores 641-64M will be sent to the Element Evaluation System 604. If there are any new event operations generated from the element evaluation operations, the Element Evaluation System 604 will send a new batch of event operation requests back to the Event Processing System 602. Another iteration of event operation processing cycle will start again.

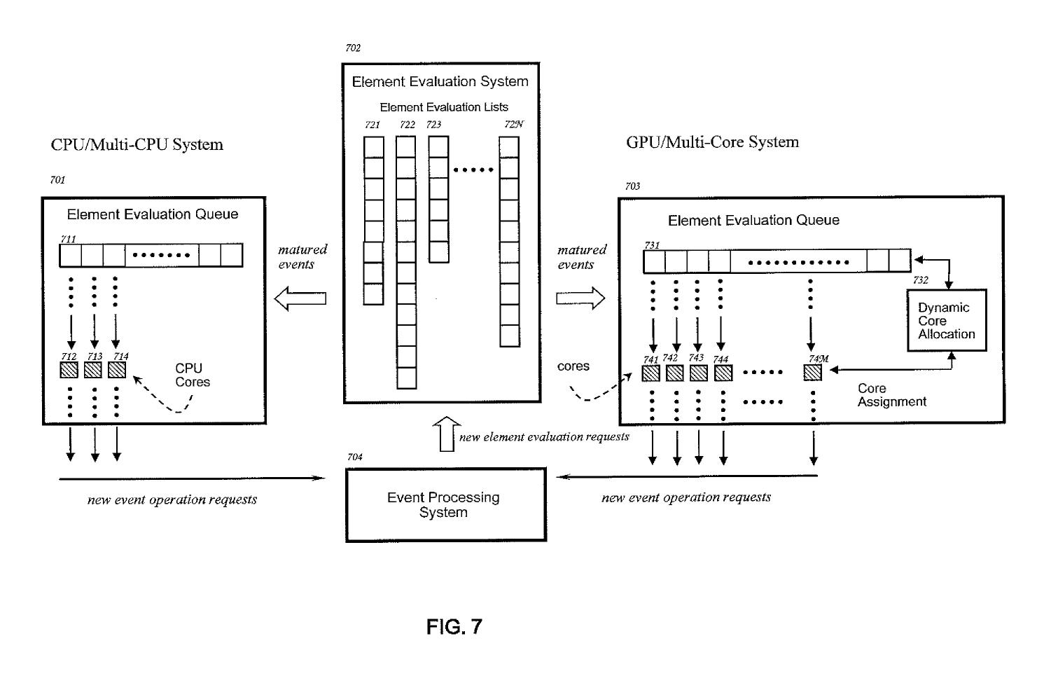

FIG. 7 shows an element evaluation system in the simulation engine using the mixed event processing and element evaluation flow of FIG. 5, in accordance with the present invention. First, new element evaluation operation requests are sent to the Element Evaluation System 702. Operation requests are stored in Element Evaluation Lists 721-72N. A request will be fetched from the Element Evaluation Lists 721-72N, and depending on the nature of the request, will be sent to either the CPU/Multi-CPU System 701 or the GPU/Multi-Core System 703. New element evaluation operation requests will be stored in the Element Evaluation Queues 711 and 751, respectively. Next for the CPU/Multi-CPU System 701, element evaluation operation requests will be picked up from the Element Evaluation Queue 711, and processed by the CPU cores 712-714. Any new event operation requests generated by the cores will be fed to the Event Processing System 704 which will perform event operations. If there are any new element evaluation operation requests generated from the event operations, the Event Processing System 704 will send a new batch of element evaluation operation requests back to the Element Evaluation System 702.

On the right side of FIG. 7, new element evaluation requests for the GPU/Multi-Core System 703 will be stored at the Element Evaluation Queue 731. Next, the Dynamic Core Allocation System 732 will search for any free cores, pick up an element evaluation operation request from the queue 731, and assign the operation to a next available core. The function of the Dynamic Core Allocation System 732 is to keep each of the cores 741-74M busy all the time. No core shall stay idle. Any new event operation requests generated from the cores 741-74M will be sent to the Event Processing System 704. If there are any new element evaluation operations generated from the event operations, the Element Evaluation System 704 will send a new batch of event operation requests back to the Element Evaluation 702. Another iteration of element evaluation operation processing cycle will start again.

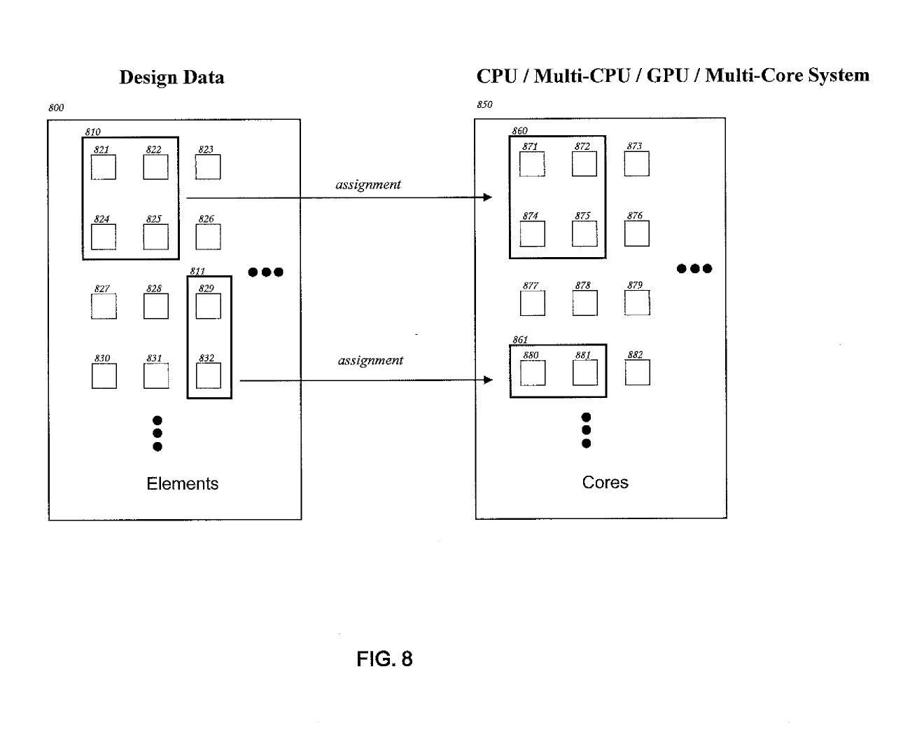

FIG. 8 shows a first embodiment of a design partition based optimization method, in accordance of the present invention. The Structure/Topology Based Partition Method is a design partition based optimization method to further improve the simulation performance. Design Data 800 contains elements 821-832 and more. An element may be as small as a transistor or a logic gate. An element may also be as large as a module or a set of modules. An element may also be a collection of atomic operations happening in a transistor, a cell, a module, or a set of modules. Several elements may form an element group. For example, the element group 810 contains the elements 821, 822, 824, and 825. The elements 829 and 832 belong to the element group 811. In the element group 810, elements 821, 822, 824, and 825 may be logically and/or functionally related. In the element group 811, elements 829 and 832 may be logically and/or functionally related. Element groups 810 and 811 may be logically and/or functionally independent. It is also possible that element groups 810 and 811 may be logically and/or functionally dependent. Groups 810 and 811 may have certain data overlapped, or have certain signals connected.

The CPU/Multi-CPU/GPU/Multi-Core System 850 contains core 871-882 and more. Several cores in the CPU/Multi-CPU system or in the GPU/Multi-Core System may form a core group. In the GPU/Multi-Core System 850, the cores 871, 872, 874, and 875 form a core group 860. The core group 861 contains cores 880 and 881.

During a simulation, the element group 810 may be assigned to the core group 860. The element group 811 may be assigned to the core group 861. An element group to core group assignment means the cores in the core group may process a certain number of atomic operations happening in the elements of the element group. The element group to core group assignment may be permanent, or may be valid for a certain period of time. For each element group to core group assignment, the numbers of elements and the number of cores may not be equal. An element may not belong to an element group permanently. The elements 821, 822, 824, and 825 may not belong to the element group 810 permanently. A core may not belong to a core group permanently. The cores 880 and 881 may not belong to the core group 861 permanently. The element groups 810 and 811 may not exist permanently. The core groups 860 and 861 may not exist permanently.

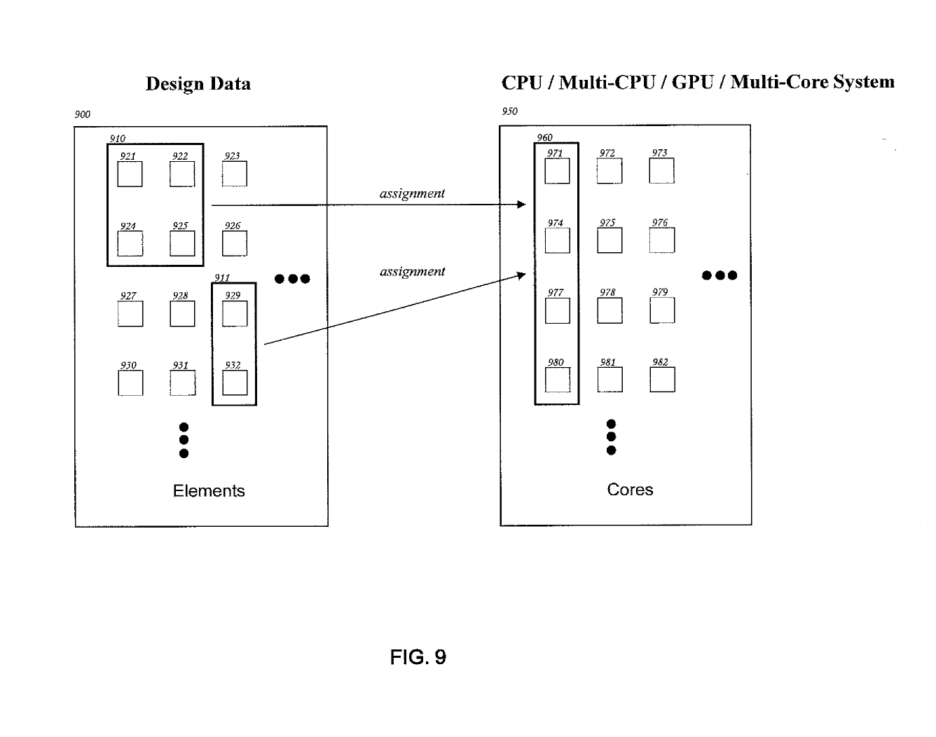

FIG. 9 shows a second embodiment of a design partition based optimization method, in accordance of the present invention. The Overlapped Design Partition Method is a design partition based optimization method to further improve the simulation performance. The Design Data 900 contains the elements 921-932 and more. The elements 921, 922, 924, and 925 form the element group 910. The elements 929 and 932 belong to the element group 911. The CPU/Multi-CPU/GPU/Multi-Core System 950 contains the cores 971-982 and more. The cores 971, 972, 974, and 975 form the core group 960. During a simulation, both element groups 910 and 911 will be assigned to the core group 960. The element groups 910 and 911 may be logically and/or functionally independent. Ideally the data exchanges and signal connections between 910 and 911 may be minimal. For each element group to core group assignment, the numbers of elements and the number of cores may not be equal. There may be more than two element groups to be assigned to one core group.

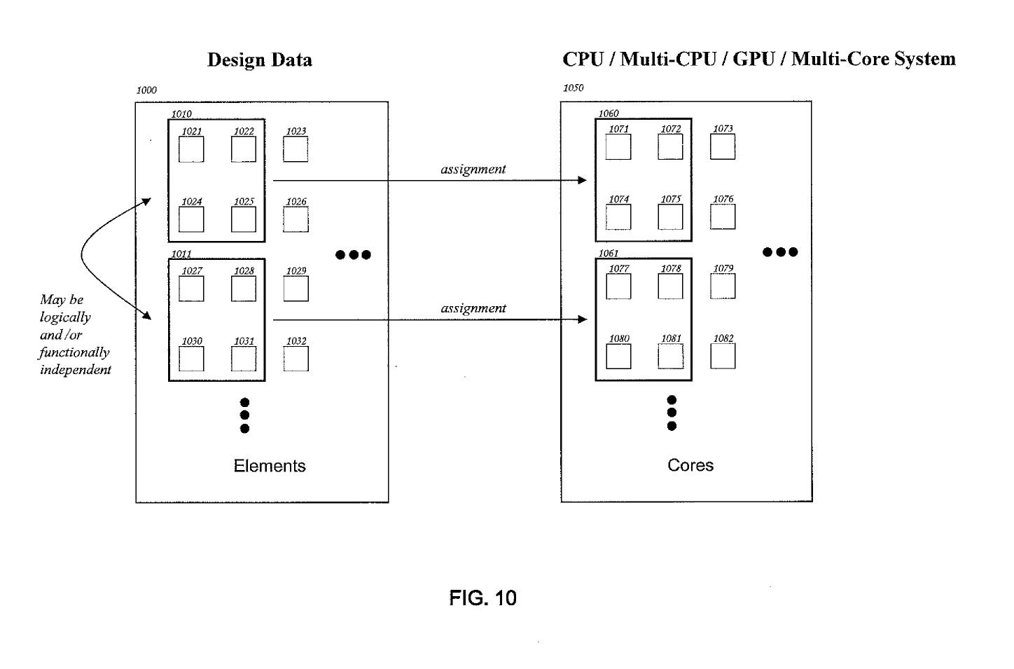

FIG. 10 shows a third embodiment of a design partition based optimization method, in accordance of the present invention. The Functional Partition Method #1 is a design partition based optimization method to further improve the simulation performance. The Design Data 1000 contains the elements 1021-1032 and more. The elements 1021, 1022, 1024, and 1025 form the element group 1010. The elements 1027, 1028, 1030, and 1031 belong to the element group 1011. The CPU/Multi-CPU/GPU/Multi-Core System 1050 contains cores 1071-1082 and more. The cores 1071, 1072, 1074, and 1075 form the core group 1060. The cores 1077, 1078, 1080, and 1081 form the core group 1061. The element groups 1010 and 1011 may have similar functionalities or simulation operations in the design. The elements in the element group 1010 may be logically and/or functionally independent of the elements in the element group 1011. It is also possible that the elements in the element group 1010 may have limited data exchanges and signal connections with the elements in the element group 1011. During a simulation, the element group 1010 is assigned to the core group 1060, and the element group 1011 is assigned to the core group 1061. Since the simulation operations happening in the element group 1010 may have little data exchanges with the simulation operations happening in the element group 1011, the cores of the core groups 1060 and 1061 may process their assigned simulation operations at full speed.

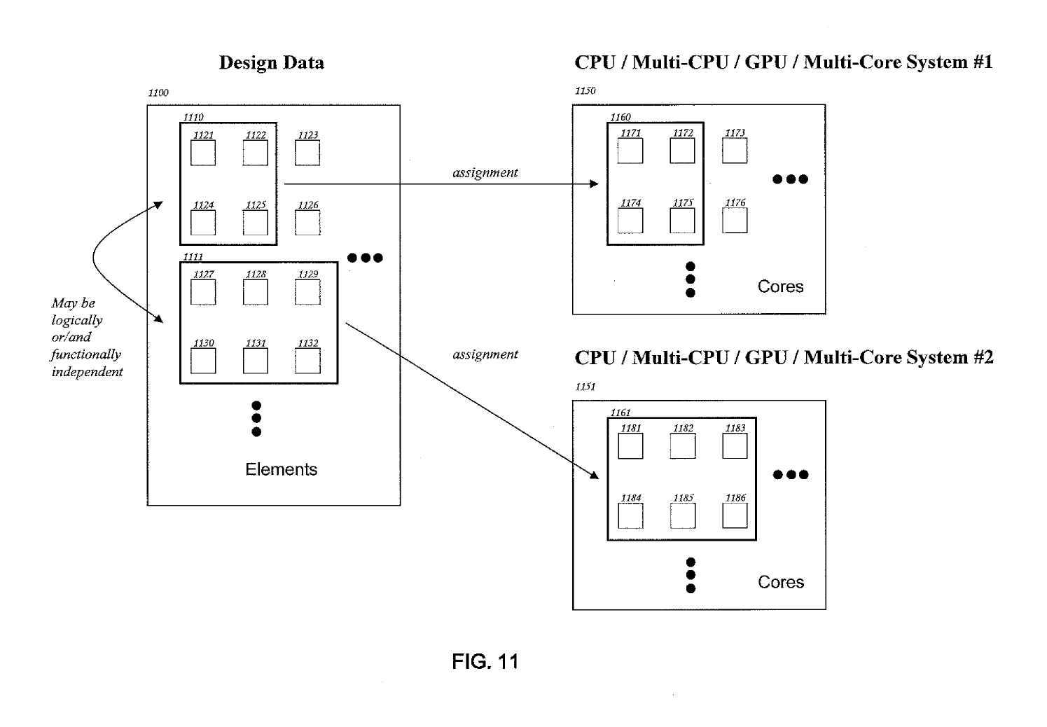

FIG. 11 shows a fourth embodiment of a design partition based optimization method, in accordance of the present invention. The Functional Partition Method #2 is a design partition based optimization method to further improve the simulation performance. The Design Data 1100 contains the elements 1121-1132 and more. The elements 1121, 1122, 1124, and 1125 form the element group 1110. The elements 1127, 1128, 1129, 1130, 1131, and 1132 form the element group 1111. The CPU/Multi-CPU/GPU/Multi-Core System #1 1150 contains the cores 1171-1176 and more. The CPU/Multi-CPU/GPU/Multi-Core System #2 1151 contains the cores 1181-1186 and more. The cores 1171, 1172, 1174, and 1175 form the core group 1160. The core 1181, 1182, 1183, 1184, 1185, and 1186 form the core group 1161. The element groups 1110 and 1111 may have similar functionalities or simulation operations in the design. The elements in the element group 1110 may be logically and/or functionally independent of the elements in the element group 1111. The elements in the element group 1110 may have limited data exchanges and signal connections with the elements in the element group 1111. During a simulation, the element group 1110 is assigned to the core group 1160, and the element group 1111 is assigned to the core group 1161. Since the simulation operations happening in the element group 1110 may have little data exchanges with the simulation operations happening in the element group 1111, the cores of the core groups 1160 and 1161 may process their assigned simulation operations at full speed. The simulator may control more than two CPU/Multi-CPU/GPU/Multi-Core systems. The Functional Partition Method #2 can be expanded to include more than two GPU/Multi-Core systems.

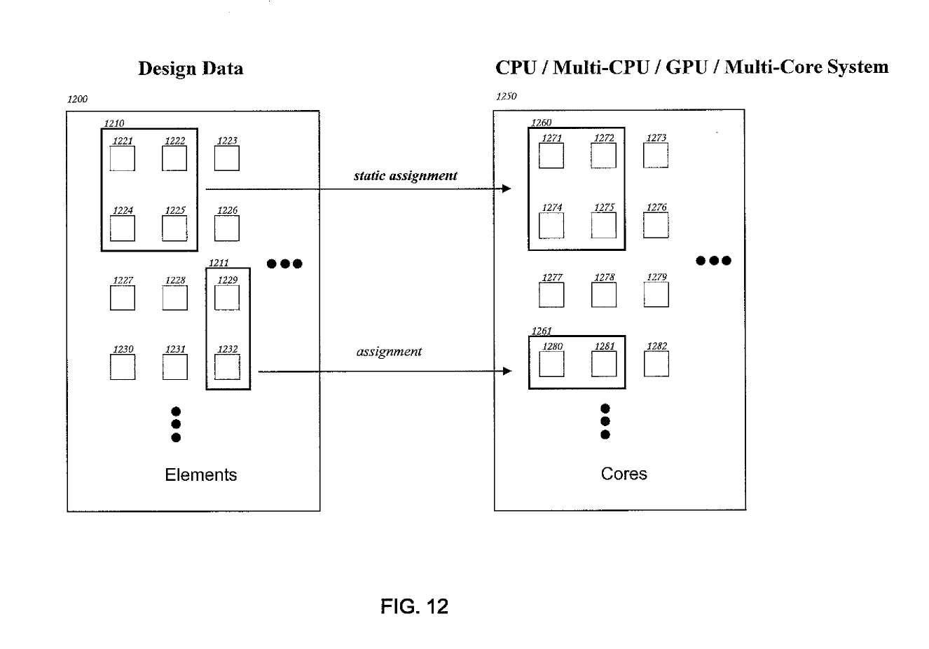

FIG. 12 shows a fifth embodiment of a design partition based optimization method, in accordance of the present invention. The Static Partition method is a design partition based optimization method to further improve the simulation performance. The Design Data 1200 contains the elements 1221-1232 and more. The elements 1221, 1222, 1224, and 1225 form the element group 1210. The elements 1229 and 1232 belong to the element group 1211. The CPU/Multi-CPU/GPU/Multi-Core System 1250 contains the cores 1271-1282 and more. The cores 1271, 1272, 1274, and 1275 form the core group 1260. The core group 1261 contains the cores 1280 and 1281. During a simulation, the element group 1211 may be assigned to the core group 1261. This element group to core group assignment may be only valid for a certain period of time. The assignment of the element group 1210 to the core group 1260 may be static. A static element group to core group assignment means the element group 1210 may be assigned to the core group 1260 from the beginning of a simulation to the end of the simulation. If the element group 1210 keeps creating new simulation operations during the simulation, a static element group to core group assignment will ensure the core group 1260 may process the simulation operations of element group 1210 with a better performance.

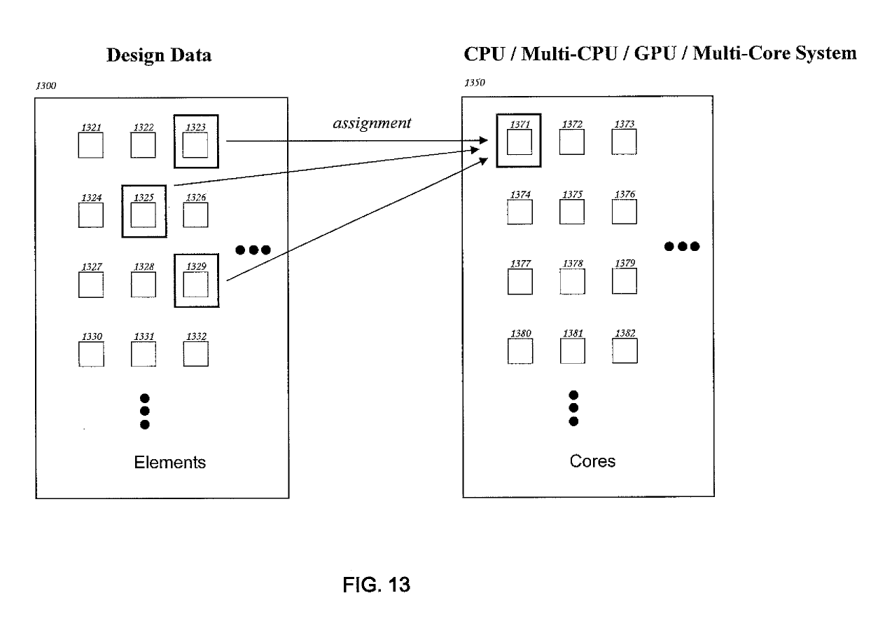

FIG. 13 shows an sixth embodiment of a design partition based optimization method, in accordance of the present invention. The Single Core Assignment Method is a design partition based optimization method to further improve the simulation performance. The Design Data 1300 contains the elements 1321-1332 and more. The CPU/Multi-CPU/GPU/Multi-Core System 1350 contains the cores 1371-1382 and more. If the elements 1323, 1325, and 1329 are logically and/or functionally independent, and they may generate simulation operations at a different time in a simulation, then they may be assigned to the same core 1371.

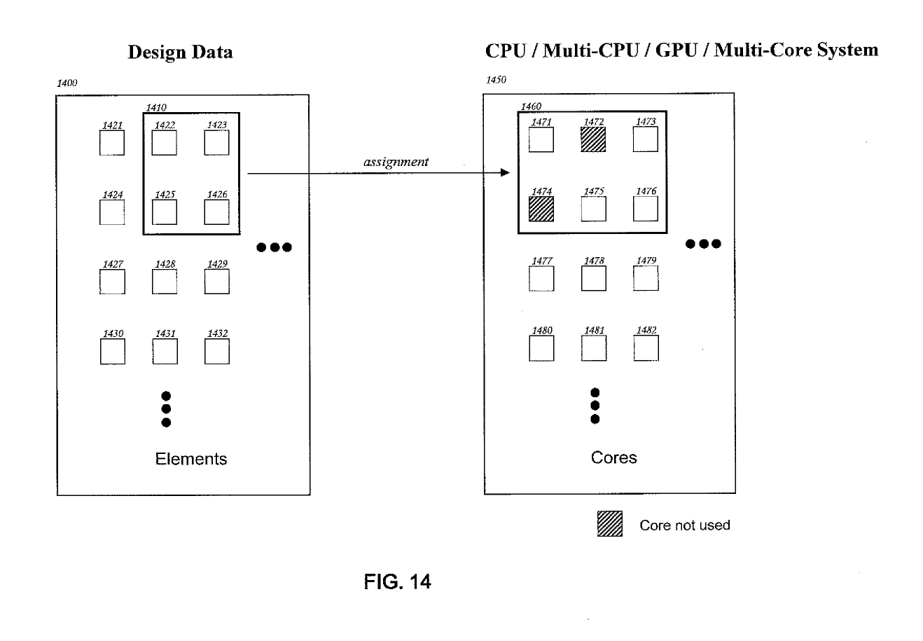

FIG. 14 shows a seventh embodiment of a design partition based optimization method, in accordance of the present invention. The Sparse Partition Method is a design partition based optimization method to further improve the simulation performance. The Design Data 1400 contains the element 1421-1432 and more. The elements 1422, 1423, 1425, and 1426 form the element group 1410. The CPU/Multi-CPU/GPU/Multi-Core System 1450 contains the cores 1471-1482 and more. The cores 1471, 1472, 1473, 1474, 1475, and 1476 form the core group 1460. During a simulation, the element group 1410 will be assigned to the core group 1460. This element group to core group assignment may be only active for a certain period of time. The cores 1472 and 1474 in the core group 1460 may not be used to process simulation operations; they may stay idle during the period of the element group to core group assignment. This may reduce the computation activities in the core group 1460. The memory traffic in the core group 1460 may be reduced; hence the over-all simulation performance of the core group 1460 may be improved.

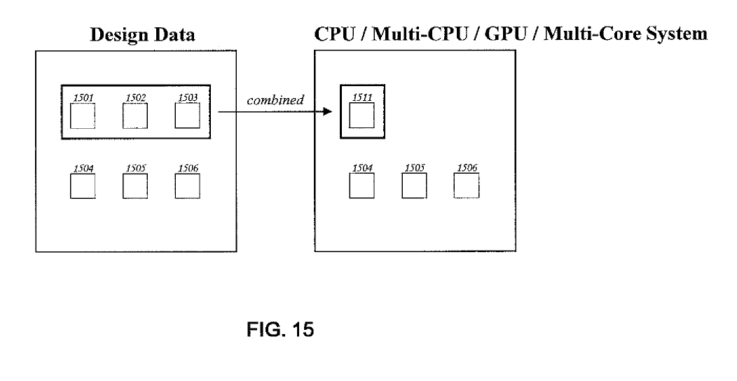

FIG. 15 shows a first embodiment of a data based optimization method, in accordance with the present invention. The Element Compaction Method is a data based optimization method to further improve the simulation performance. The Design Data contains the elements 1501-1506. The elements 1501, 1502, and 1503 are small elements. They can be combined to create a new big element 1511. Smaller design elements (or element in short) may be combined to become one big design element. With fewer design elements to simulate, the simulation may become faster. The Element Compaction Method may be applied to gate-level, RTL, behavioral-level, or higher-level elements.

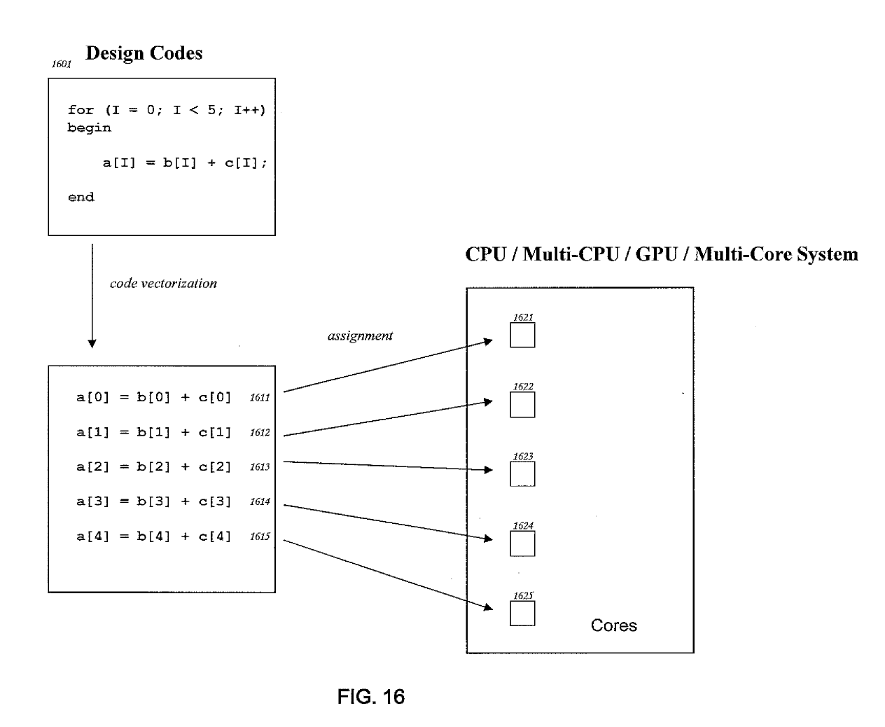

FIG. 16 shows a second embodiment of a data based optimization method, in accordance with the present invention. The Design Element Vectorization Method is a data based optimization method to further improve the simulation performance. The Design Codes 1601 contains a ‘for’ loop. The ‘for’ loop can be expanded to simple statements 1611-1615. Next, the statement 1611 which is considered as an element will be assigned to the core 1621. Respectively, the statement 1612 will be assigned to the core 1622; the statement 1613 will be assigned to the core 1623; the statement 1614 will be assigned to the core 1624; and the statement 1615 will be assigned to the core 1625. These five statements to core assignments may have the statements 1611-1615 simulated at the same time to improve the overall simulation time.

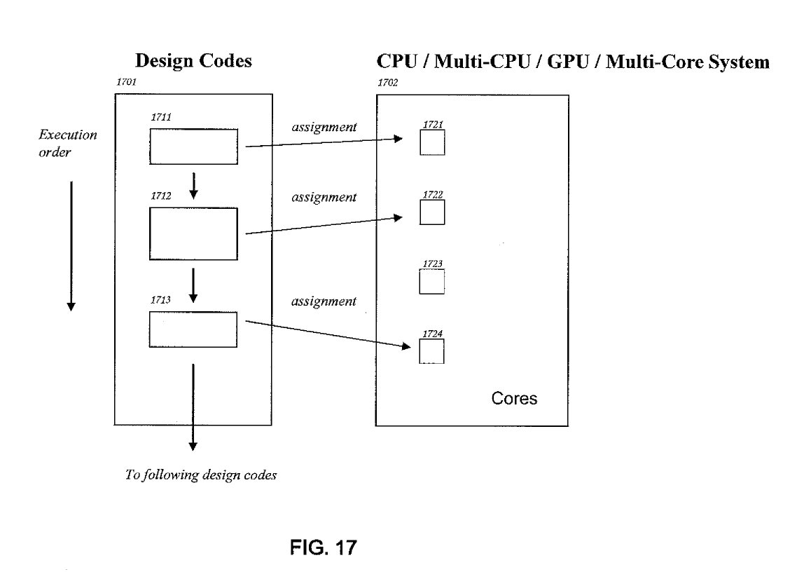

FIG. 17 shows a third embodiment of a data based optimization method, in accordance with the present invention. The Code Splicing Method is a data based optimization method to further improve the simulation performance. The Design Codes 1701 contains three code segments 1711, 1712, and 1713. A code segment is defined as a set of design statements. In the Design Codes 1701, the code segment 1712 will be simulated after the code segment 1711, and the code segment 1713 will be simulated after 1712. The code segment 1713 will be followed by other code segments. The data and functions of the code segments 1711, 1712, and 1713 may be independent of one another, i.e., the order of simulation among the code segments 1711, 1712, and 1713 may not have to be fixed. The code segment 1713 can be simulated before the code segment 1711, and the result of the simulation will be identical to the simulation result of simulating the code segment 1711 before the code segment 1713. Similarly, the code segment 1712 can be simulated before the code segment 1711. If the code segments 1711, 1712, and 1713 can be found in the design codes, it will be possible to assign each code segment to a separate core or a core group. The code segment 1711 is assigned to the core 1721; the code segment 1712 is assigned to the core 1722; and the code segment 1713 is assigned to the core 1724. The code segments 1711, 1712, and 1713 may be simulated at the same time to improve the simulation performance.

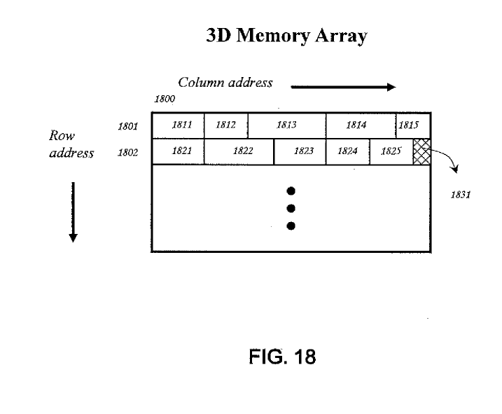

FIG. 18 shows a fourth embodiment of a data based optimization method, in accordance with the present invention. The Method for Handling of a 3-Dimentional (3D) Memory Array is a data based optimization method to further improve the simulation performance. Traditional memory array is a collection of memory entries accessed through a memory address. Each memory entry is usually 8-bit wide. A memory array looks like a two-dimensional (2D) data array. Each entry is deemed as a row in the 2D memory array. The 2D memory array only has one column. The column size is the same as the entry size which is usually 8-bit wide. A memory address will select a specific row in the 2D memory array, and the specific row only contains one memory entry. A 3D memory array also comprises memory entries organized as rows and columns. The main difference between a 3D memory array and a 2D memory array is that each row in a 3D memory array may contain more than one memory entries. This means one memory row may contain more than one column where each column stands for one separate memory entry. Other than an address to select the memory row, a 3D memory array will need a column address to select the specific column in a row. A row address and a column address are required to select a specific memory entry in a 3D memory array.

An example 3D memory 1800 which has the memory rows 1801-1802 and more is shown in FIG. 18. Each row may have more than 256 bytes. The memory row 1801 stores the design elements (or elements in short) 1811-1815. The memory row 1802 stores the design elements 1821-1825. 1802. The design elements 1811-1815 may be logically and/or functionally related. They may need to be simulated within a short time frame from one another. Similarly, the design elements 1821-1825 may be neighboring design elements in the design. The data of design elements may not be of the same size. It is possible that multiple elements cannot fit into one memory row. This will leave unused memory space at the end of a memory row. The gap area 1831 is one unused memory space in the memory row 1802. Future CPU/Multi-CPU/GPU/Multi-Core system may adapt some 3D memory architecture. The 3D memory array may be accessed one row at a time. By storing neighboring design elements or logically/functionally related design elements in one memory row, the memory access time will be reduced hence improving the simulation performance.

Other traditional programming language optimization techniques can be applied to the present invention. These techniques may include dead code removal; function redundancy removal; un-reachable code removal; pre-calculation of design elements which have constant output values; data pre-fetching; code segments re-ordering; direct C/C++ language or assembly code generation; and data compaction for parallel operations, for instance, four one-byte addition operations can be combined into one single 32-bit addition operation.

Having thus described and illustrated specific embodiments of the present invention, it is to be understood that the objectives of the invention have been fully achieved. And it will be understood by those skilled in the art that many changes in construction and circuitry, and widely differing embodiments and applications of the invention will suggest themselves without departing from the spirit and scope of the present invention. The disclosures and the description herein are intended to be illustrative and are not in any sense limitation of the invention, more preferably defined in scope by the following claims.

What is claimed is:

1. A method to build a unified simulator for simulating a design on a parallel computing platform, the design being modeled in a high-level hardware description language; the parallel computing platform comprising two or more (processors) cores which are deemed as an integral part of the said unified simulator; said method further comprises:
(a) translating said design into a set of elements each comprising one or more simulation operations;
(b) assigning said simulation operations of said elements to said cores, dynamically or statically; and
(c) simulating said simulation operations on said cores before released to process other simulation operations.

2. The method of claim 1, wherein said core is selectively a central processing unit (CPU), a core embedded in a CPU, a core in a multi-CPU system, a core embedded in a graphics processing unit (GPU), or a core in a multi-core system; wherein said multi-CPU system is a first computing system which includes multiple central processing units (CPUs); and wherein said multi-core system is a second computing system which includes multiple cores; wherein a CPU/multi-CPU system is a third computing system which includes said CPU and said multi-CPU system; and a GPU/multi-more system is a fourth computing system which includes said GPU and said multi-core system.

3. The method of claim 1, wherein said simulation operation further includes one or more atomic operations; wherein said atomic operation is a basic and smallest simulation operation which includes a matured event processing operation, a logic circuit evaluation operation, a high-level hardware description language statement evaluation operation, a new event scheduling operation, or another basic simulation operation; wherein said atomic operation is processed by one said core.

4. The method of claim 1, wherein said element includes a transistor, a logic gate, a cell, a register-transfer-level (RTL) statement, a behavioral-level statement, a higher-level statement, a gate-level module, a RTL-level module, a behavioral-level module, a higher-level module, or a mixture of multiple said modules; wherein said module is described with a transistor-level statement, a gate-level statement, an RTL-level statement, a behavioral-level statement, a higher-level statement, or a mixture of any two or more said statements.

5. The method of claim 1, further comprising using a design partition based optimization method to further improve simulation performance.

6. The method of claim 5, wherein said design partition based optimization method further includes a structure/topology based partition method; wherein said structure/topology based partition method further comprises selecting one or more said elements to form an element group; and assigning said element group to a core group which includes one or more said cores; wherein said one or more said elements are assigned to said element group, dynamically or statically, and said one or more said cores are assigned to said core group, dynamically or statically.

7. The method of claim 5, wherein said design partition based optimization method further includes an overlapped partition method; wherein said overlapped partition method further comprises allowing two or more element groups to be assigned, dynamically or statically, to one said core group which includes one or more said cores; wherein said element group includes one or more said elements; and wherein said one or more said elements are assigned to said element group, dynamically or statically, and said one or more said cores are assigned to said core group, dynamically or statically.

8. The method of claim 5, wherein said design partition based optimization method further includes a functional partition method; wherein said functional partition method further comprises identifying element groups in said design, where each said element group is functionally or logically independent of one another, and each said element group is assigned, dynamically or statically, to a different core group which consists of one or more said cores; wherein said element group includes one or more said elements, and said core group includes one or more said cores; and wherein said one or more said elements are assigned to said element group, dynamically or statically, and said one or more said cores are assigned to said core group, dynamically or statically.

9. The method of claim 5, wherein said design partition based optimization method further includes a static partition method; wherein said static partition method further comprises identifying one or more element groups; and assigning each said element group statically to a different core group which includes one or more said cores; wherein said element group includes one or more said elements; and wherein said one or more said elements are assigned to said element group, dynamically or statically, and said one or more said cores are assigned to said core group, dynamically or statically.

10. The method of claim 5, wherein said design partition based optimization method further includes a single core assignment method; wherein said single core assignment method further comprises assigning a group of said elements, dynamically or statically, to a single core; wherein each said element in said group of said elements is functionally or logically independent of one another.

11. The method of claim 5, wherein said design partition based optimization method further includes a sparse partition method; wherein said sparse partition method further comprises choosing one or more said elements to form an element group; and assigning said element group, dynamically or statically, to a core group which includes one or more said cores; wherein said one or more said cores in said core group are not used to process said simulation operations, and may stay idle; and wherein said one or more said elements are assigned to said element group, dynamically or statically, and said one or more said cores are assigned to said core group, dynamically or statically.

12. The method of claim 1, further comprising using a data based optimization method to further improve simulation performance.

13. The method of claim 12, wherein said data based optimization method further includes an element compaction method; wherein said element compaction method further comprises combining two or more said elements into a new big element; wherein said new big element is assigned to a said core, dynamically or statically, to reduce the number of simulation operations.

14. The method of claim 12, wherein said data based optimization method further includes a design element vectorization method; wherein said design element vectorization method further comprises expanding a loop statement into a set of single statements; wherein each said single statement is considered as one new element, and each said new element is assigned to a different said core, dynamically or statically, to simulate in parallel.

15. The method of claim 12, wherein said data based optimization method further includes a code splicing method; wherein said code splicing method further comprises examining the original language statements of said design; identifying sequential code blocks where each said code block may have no data and execution order dependency on one another; constructing each said code block as a new element group; and assigning each said new element group, dynamically or statically, to a different core group which includes one or more said cores to simulate in parallel.

16. The method of claim 12, wherein said data based optimization method further includes a 3-dimentional (3D) optimization method to support a 3D memory array; wherein said 3D optimization method further comprises identifying certain elements, which are nearby elements, logically/functionally related elements, or elements having certain mutual relationships, in said design; and storing said certain elements in the same data row of said 3D memory array, where unused memory space is left at the end of said data row.

17. The method of claim 12, wherein said data based optimization method further includes a conventional programming language optimization method; wherein said conventional programming language optimization method further includes a dead code removal method, a function redundancy removal method, an un-reachable code removal method, a pre-calculation method of design elements which have constant output values, a data pre-fetching method, a code segments re-ordering method, a direct C/C++ language or assembly code generation method, a data compaction for parallel operation method, or a combination of any of the above methods.

18. The method of claim 1, wherein said unified simulator processes said simulation operations on said cores further comprises using an operation processing system under the control of one or more said cores.

19. The method of claim 18, wherein said operation processing system has a direct control over every available said core, and does not rely on a third-party simulator to simulate part of said elements on said cores.

20. The method of claim 2, wherein said unified simulator processes said simulation operations on said cores further comprises processing new operation requests on one or more operation processing systems.

21. The method of claim 20, wherein a first said operation processing system comprises using operation request lists to accept a first set of new operation requests; forwarding said first set of new operation requests to one said CPU/multi-CPU system or one said GPU/multi-core system; assigning operation requests, dynamically or statically, to available said cores in said CPU/multi-CPU system or said GPU/multi-core; generating a second set of new operation requests after said cores process said operation requests; selectively having a second said operation processing system processed said second set of new operation requests to generate a third set of new operation requests; sending said second set of new operation requests or said third set of new operation requests back to said first said operation processing system to start another iteration of new operation requests processing.

22. The method of claim 21, wherein said first operation processing system or said second operation processing system is selectively an event processing system to process event processing requests or an element evaluation system to process element evaluation requests; wherein said event processing is one said simulation operation to process simulation events, and said element evaluation is one said simulation operation to perform element evaluations.

23. The method of claim 22, wherein said event processing system comprises using event lists to accept a first set of new event processing requests; forwarding said first set of new event processing requests to one CPU/multi-CPU system or one said GPU/multi-core system; assigning event processing requests, dynamically or statically, to available said cores in said CPU/multi-CPU system or said GPU/multi-core system; generating a second set of new element evaluation requests after said cores process said event processing requests; having said element evaluation system processed said second set of new element evaluation requests to generate a third set of new event processing requests; sending said second set of new operation requests or said third set of new operation requests back to said event processing system to start another iteration of new event processing requests processing.

24. The method of claim 22, wherein said element evaluation system comprises using element evaluation lists to accept a first set of new element evaluation requests; forwarding said first set of new element evaluation requests to one said CPU/multi-CPU system or one said GPU/multi-core system; assigning event processing requests, dynamically or statically, to available said cores in said CPU/multi-CPU system or said GPU/multi-core system; generating a second set of new event processing requests after said cores process said element evaluation requests; having said event processing system processed said second set of new event processing requests to generate a third set of new element evaluation requests; sending said second set of new operation requests or said third set of new operation requests back to said element evaluation system to start another iteration of new element evaluation requests processing.

25. The method of claim 21, wherein said operation request lists store said operation requests selectively in lists, in queues, in stacks, in arrays, in temporary variables, in dynamically allocated memories, or in a mixture of above said data structures.

26. The method of claim 2, wherein said parallel computing platform comprising two or more (processor) cores which are deemed as an integral part of the unified simulator further allows all said cores to perform any said simulation operations; wherein a said simulation operation processed by a first said core present in said CPU/multi-CPU system or said GPU/multi-core system produces an execution result which is identical to that obtained from a second said core, making each said core present in said CPU/multi-CPU system or in said GPU/multi-core system possess equal functionalities to process said simulation operations.

27. The method of claim 1, wherein one or more said cores are reserved to process certain types of said simulation operations or certain elements in said design.

28. The method of claim 1, wherein said unified simulator further supports more than 4 logic values with different strength values, integer values, and floating point values to ensure compatibility with other conventional commercial simulators.

29. The method of claim 1, further comprising providing a communication link with said unified simulator to work with third-party software in creating new applications.

30. The method of claim 29, wherein said communication link is an application programming interface (API) based, a remote procedure call (RPC) based, an inter-process call based, a middle-ware based, an internet/web based, or other communication method based.

31. The method of claim 29, wherein said new application further includes mixed-signal simulation, system-level simulation, design debugging, fault diagnosis, or a mixture of two or more applications.

32. The method of claim 1, wherein said unified simulator is further adapted to various parallel computing platforms for allowing the implementation of a fault simulator, a fault diagnosis simulator, or a special-purpose high-level hardware description language simulator.
